(19) United States
(12) Patent Application Publication
(10) Pub. No.: US 2026/0302288 A1
(43) Pub. Date: Oct. 1, 2026

(54) TEMPERATURE SENSOR ABNORMALITY DETECTION DEVICE AND TEMPERATURE SENSOR ABNORMALITY DETECTION METHOD

(71) Applicant: HONDA MOTOR CO., LTD., Tokyo (JP)

(72) Inventors: Tsubasa Nishioka, Wako-shi (JP); Satoru Kawase, Wako-shi (JP)

(21) Appl. No.: 19/550,386

(22) Filed: Feb. 26, 2026

(30) Foreign Application Priority Data
Mar. 26, 2025 (JP) 2025-051955

(51) Int. Cl. H01M 8/0432; H01M 8/04992

(52) U.S. Cl. CPC H01M 8/0432; H01M 8/04992

(57) ABSTRACT

A temperature sensor abnormality detection device includes a temperature sensor abnormality detection part configured to identify a temperature sensor with a largest deviation between an average value of temperatures detected by a plurality of temperature sensors and a temperature detected by each of the plurality of temperature sensors, determine that an abnormality has occurred in the identified temperature sensor when a temperature detected by the identified temperature sensor is a minimum value among temperatures detected by the plurality of temperature sensors and a deviation of the identified temperature sensor is equal to or greater than a predetermined value, and determine that an abnormality has occurred in the plurality of temperature sensors other than the identified temperature sensor when the temperature detected by the identified temperature sensor is a maximum value among the temperatures detected by the plurality of temperature sensors.

### CROSS-REFERENCE TO RELATED APPLICATION

Priority is claimed on Japanese Patent Application No. 2025-051955, filed Mar. 26, 2025, the content of which is incorporated herein by reference.

### BACKGROUND OF THE INVENTION

### Field of the Invention

The present invention relates to a temperature sensor abnormality detection device and a temperature sensor abnormality detection method.

### Description of Related Art

In recent years, research and development into fuel cell systems that contribute to energy efficiency has been conducted to ensure that more people have access to affordable, reliable, sustainable, and advanced energy.

In a technology related to the fuel cell system, for example, a temperature inside each of a plurality of tanks is detected using a temperature sensor attached to each tank. When a detected value of the temperature sensor detecting the temperature inside the tank fails, the detected value will be far from the actual value.

To prevent such abnormalities, for example, the temperature inside the tank is measured using a thermistor and the outside air temperature is detected using a temperature sensor. Temperatures of different tanks are then compared, and the largest temperature difference is determined to be an abnormality (refer to, for example, Patent Document 1 (Japanese Unexamined Patent Application, First Publication No. 2014-77479)).

### SUMMARY OF THE INVENTION

However, a technology described in Patent Document 1 has required a temperature sensor that detects the outside temperature. Furthermore, the conventional technology cannot identify a failed sensor, resulting in, for example, the service department taking a long time to check the sensor.

The present invention has been made in consideration of the problems described above and aims to provide a temperature sensor abnormality detection device and a temperature sensor abnormality detection method that can detect when one of temperature sensors in a plurality of tanks has failed. This will ultimately contribute to energy efficiency.

To achieve the above-mentioned objectives, the temperature sensor abnormality detection device and temperature sensor abnormality detection method of the present invention employ the following configuration.
(1) A temperature sensor abnormality detection device according to one aspect of the present invention detects abnormalities of a plurality of temperature sensors provided in each of a plurality of tanks in a tank system having the plurality of tanks. The temperature sensor abnormality detection device calculates deviations between an average value of temperatures detected by the plurality of temperature sensors and a temperature detected by each of the plurality of temperature sensors, identifies a temperature sensor with a largest deviation, determines that an abnormality has occurred in the identified temperature sensor when a temperature detected by the identified temperature sensor is a minimum value among the temperatures detected by the plurality of temperature sensors and a deviation of the identified temperature sensor is equal to or greater than a predetermined value, and determines that an abnormality has occurred in the plurality of temperature sensors other than the identified temperature sensor when a temperature detected by the identified temperature sensor is a maximum value among the temperatures detected by the plurality of temperature sensors.
(2) In the temperature sensor abnormality detection device according to one aspect of (1) described above, a temperature sensor abnormality detection part may determine that an abnormality has occurred in temperature sensors with a minimum value and a second-to-minimum value of detected temperatures when a temperature detected by the identified temperature sensor is a maximum value among the temperatures detected by the plurality of temperature sensors.
(3) In the temperature sensor abnormality detection device according to one aspect of (1) described above, when a difference between a value of a temperature sensor with the maximum detected temperature and a temperature detected by another temperature sensor is equal to or greater than a predetermined value, the temperature sensor abnormality detection part may determine that an abnormality has occurred in the other temperature sensor.
(4) In the temperature sensor abnormality detection device according to one aspect of (1) described above, when a temperature of the temperature sensor with the maximum detected temperature is compared with temperatures detected by other temperature sensors, the temperature sensor abnormality detection part may perform the comparison starting from a temperature sensor with the lowest detected temperature among the other temperature sensors or a temperature sensor with the lowest detected temperature among the other temperature sensors where an abnormality has not been determined.
(5) In the temperature sensor abnormality detection device according to one aspect of (1) described above, a temperature detected by each of the plurality of temperature sensors may be a temperature when a predetermined period of time has elapsed after hydrogen release and during a period when hydrogen is not released.
(6) In the temperature sensor abnormality detection device according to one aspect of (1) described above, only a tank corresponding to the temperature sensor where an abnormality is determined to have occurred by the temperature sensor abnormality detection part may be provided with a control part that performs control by setting a remaining amount to a substitute value that is lower than the remaining amount before the abnormality is determined to have occurred.
(7) A temperature sensor abnormality detection method according to another aspect of the present invention detects abnormalities of a plurality of temperature sensors provided in each of a plurality of tanks. The temperature sensor abnormality detection method includes, by a computer of a temperature sensor abnormality detection device, calculating deviations between an average value of temperatures detected by the plurality of temperature sensors and a temperature detected by each of the plurality of temperature sensors, identifying a temperature sensor with the largest deviation, determining that an abnormality has occurred in the identified temperature sensor when a temperature detected by the identified temperature sensor is a minimum value among the temperatures detected by the plurality of temperature sensors and a deviation of the identified temperature sensor is equal to or greater than a predetermined value, and determining that an abnormality has occurred in the plurality of temperature sensors other than the identified temperature sensor when a temperature detected by the identified temperature sensor is a maximum value among the temperatures detected by the plurality of temperature sensors.

According to the aspects (1) to (7) described above, it is possible to detect when one of the sensors in each of a plurality of tanks has failed.

According to the aspect (6) described above, it is possible to prevent a situation in which fuel runs out before information indicating that fuel in a tank is low is reported.

### BRIEF DESCRIPTION OF THE DRAWINGS

FIG. 1 is a diagram which shows a configuration example of a tank system.

FIG. 2 is a diagram for describing an example of a temperature sensor abnormality detection method of a first embodiment.

FIG. 3 is a diagram for describing an example of a temperature sensor abnormality detection method of a second embodiment.

FIG. 4 is a diagram for describing an example in which a temperature sensor detects an abnormality using a deviation.

FIG. 5 is a flowchart of processing of the second embodiment.

### DETAILED DESCRIPTION OF THE INVENTION

Embodiments of the present invention will be described below with reference to the drawings. Note that a scale of each member in the drawings used in the following description has been appropriately changed to make it visible.

In all drawings used to describe the embodiments, the same reference numerals are used for components having the same function, and repeated descriptions will be omitted.

In addition, as used herein, “based on XX” means “based on at least XX” and includes cases of being based on other elements in addition to XX. Moreover, “based on XX” is not limited to cases where XX is directly used, but also includes cases of being based on XX subjected to calculation or processing. “XX” refers to any element (for example, any information).

### Tank system

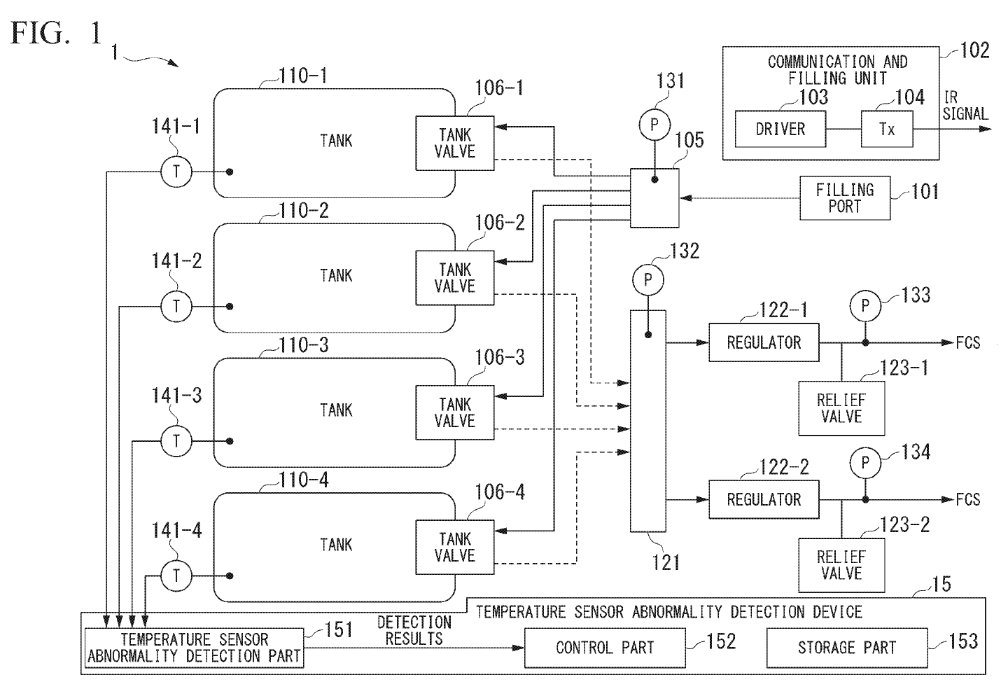

FIG. 1 shows a configuration example of a tank system 1. Note that FIG. 1 shows an example with four tanks, but the number of tanks may be three or more.

“T” (141, 141-1 to 141-4) in a white circle represents a temperature sensor. “P” (131 to 134) in white indicates a high-pressure sensor (pressure sensor).

A temperature sensor abnormality detection device 15 detects abnormalities in a plurality of temperature sensors installed in each of a plurality of tanks in the tank system 1, which has the plurality of tanks. The temperature sensor abnormality detection device 15 includes, for example, a temperature sensor abnormality detection part 151, a control part 152, and a storage part 153.

For example, hydrogen is filling through the filling port 101 and supplied to each of the tanks 110-1 to 110-4 via a filling-side manifold part 105 and a tank valve 106 (106-1 to 106-4) of the tanks.

The filling-side manifold part 105 is refolded and maintained at the same pressure. A high-pressure sensor 131 is installed in the filling-side manifold part 105.

The filling port 101 is connected to a communication and filling unit 102.

The communication and filling unit 102 includes, for example, a driver 104 and a transmitter Tx104, and outputs, for example, an infrared (IR) signal.

The tank valve 106 (106-1 to 106-4) includes, for example, a thermally activated pressure relief device (TPRD).

Each of the tanks 110-1 to 110-4 is filled with hydrogen supplied from the filling port 101. Note that the plurality of tanks 110 are assumed to have the same size and the same structure.

The tank 110 (110-1 to 110-4) is equipped with a temperature sensor 141 (141-1 to 141-4).

The temperature sensor 141 (141-1 to 141-4) are, for example, a thermistor, and detects a temperature inside the tank 110.

When hydrogen is supplied from the tank 110 (110-1 to 110-4) to a fuel cell system FC (Fuel Cell) S, it is supplied to a supply-side manifold part 121 via the tank valve 106 (106-1 to 106-4).

An inside of the supply-side manifold part 121 is refolded and maintained at the same pressure. The supply-side manifold part 121 is equipped with a high-pressure sensor 132.

The hydrogen supplied to the supply-side manifold part 121 is depressurized by a regulator 122 (122-1 to 122-2) and a relief valve 123 (123-1 to 123-2) and then supplied to the FCS. High-pressure sensors 133 and 134 are attached to a supply path.

The temperature sensor abnormality detection part 151 acquires detected temperature data from each of the temperature sensors 141-1 through 141-4. Using the acquired temperature data, the temperature sensor abnormality detection part 151 detects abnormalities in the temperature sensors 141-1 through 141-4 and outputs the detection results to the control part 152. The temperature sensor abnormality detection part 151 detects abnormalities by calculating a deviation between the average value of temperatures detected by the plurality of temperature sensors and a temperature detected by each of the temperature sensors. A method for detecting an abnormality will be described below.

The control part 152 controls each functional part of the tank system 1. The control part 152 controls each functional part of the tank system 1 based on a detection result output by the temperature sensor abnormality detection part 151.

The storage part 153 stores a threshold value used to detect an abnormality of a temperature sensor. The storage part 153 stores programs, algorithms, equations, number of tanks, and the like used by the temperature sensor abnormality detection part 151 and control part 152 for processing.

### First embodiment

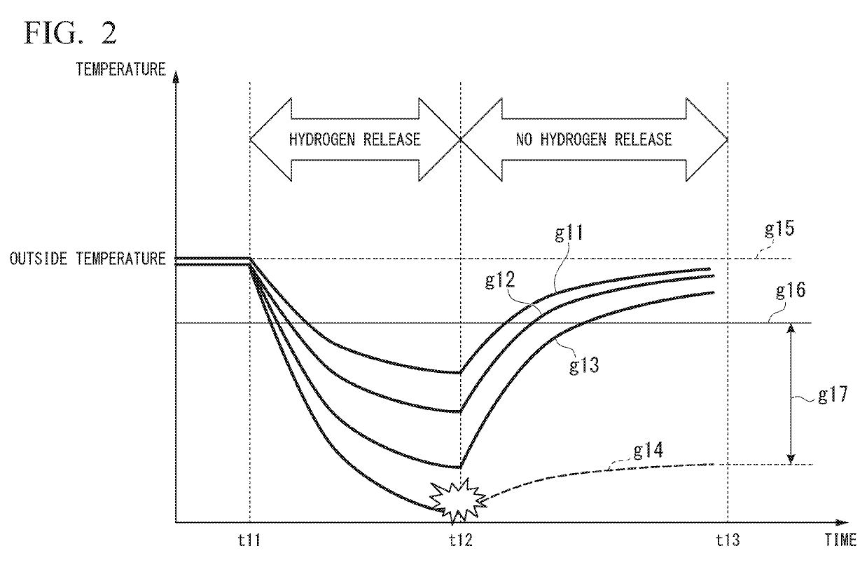

FIG. 2 is a diagram for describing an example of a temperature sensor abnormality detection method of the first embodiment. The example in FIG. 2 shows an example in which one of the four temperature sensors 141 fails.

A period between times t11 and t12 is a period during which hydrogen is released from the tank 110. A period between times t12 and t13 is a period during which hydrogen is not released from the tank 110. Note that the period between the times t12 and t13 is a period of time during which a difference from the outside temperature after hydrogen release falls within a predetermined value when the temperature sensor 141 is normal.

In FIG. 2, the horizontal axis represents a time (seconds) and the vertical axis represents a temperature (degrees). A line g11 represents a detected temperature in a first tank 100-1. A line g12 represents a detected temperature in a second tank 100-2. A line g13 represents a detected temperature in a third tank 100-3. A dash line g14 represents a detected temperature in the fourth tank 100-4. A dash line g15 represents the outside temperature. A line g16 represents an average value of temperatures of the tanks 110-1 through 110-4 between times t11 and t13.

When the temperature sensor 141 is normal, as shown in the lines g11 to g13, the temperature drops from the outside temperature during a hydrogen release period, and then approaches the outside temperature from the temperature that has dropped during a period when hydrogen is not released.

On the other hand, when the temperature sensor 141 is abnormal, as shown in the dash line g14, the temperature drops from the outside temperature during the hydrogen release period, but does not approach the outside temperature from the temperature that has dropped during the period when hydrogen is not released.

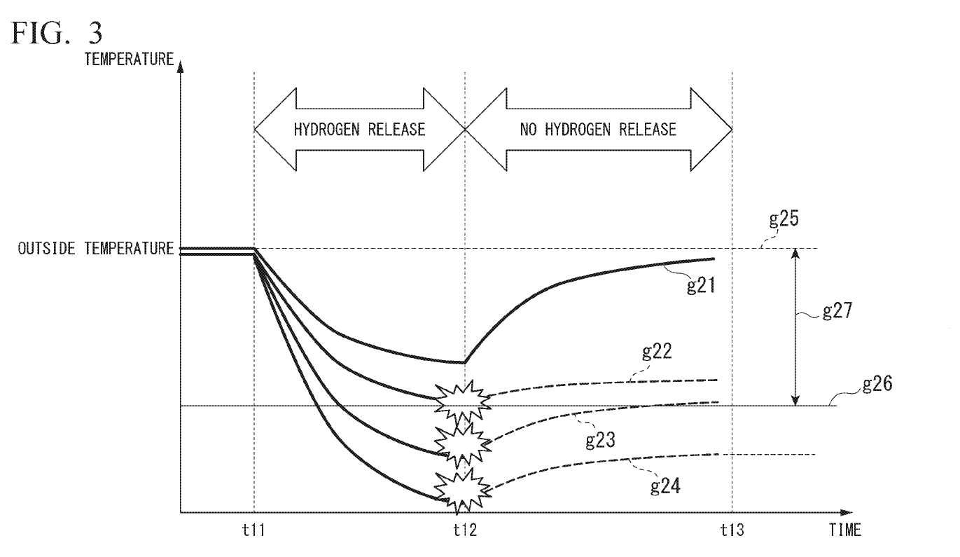

The temperature sensor abnormality detection part 151 compares an average value of temperatures with a temperature detected by each temperature sensor 141 at a time t13, and detects that an abnormality has occurred when the difference is greater than or equal to the threshold value. In other words, the temperature sensor abnormality detection part 151 compares a value of a temperature sensor with the maximum temperature with a temperature detected by each temperature sensor (another temperature sensor). When there is a deviation of a predetermined value or more, it determines that the other temperature sensor is abnormal. This is because when not all temperature sensors are abnormal, for example, a temperature detected by a normal temperature sensor will be the highest, as shown in FIG. 3 below. For example, as shown in FIG. 2, when a temperature sensor 141-4 in the fourth tank 110-4 fails, a difference between the average value (line g16) and a temperature detected by the temperature sensor 141-4 (dash line g14) will be greater than or equal to the threshold value, as indicated by a double-headed arrow g17.

As a result, according to the present embodiment, it is possible to identify which temperature sensor has failed even without an external temperature sensor that detects the outside temperature. In addition, according to the present embodiment, it is possible to detect failures even when a plurality of temperature sensors have failed.

Note that FIG. 2 is an image diagram for description and does not represent actual measurements or simulation results. Therefore, measurement results and changes are not limited to these shown here.

### Second embodiment

FIG. 3 is a diagram for describing an example of the temperature sensor abnormality detection method of the second embodiment. In the example shown in FIG. 3, three of the four temperature sensors 141 fail.

In FIG. 3, the horizontal axis represents a time (seconds) and the vertical axis represents a temperature (degrees). A line g21 represents the detected temperature in the first tank 100-1. A dash line g22 represents the detected temperature in the second tank 100-2. A dash line g23 represents the detected temperature in the third tank 100-3. A dash line g24 represents the detected temperature in the fourth tank 100-4. A dash line g25 represents the outside temperature. A line g26 represents an average value of the tanks 110-1 to 110-4 between the times t11 andt13.

When the temperature sensor 141 is normal, as shown in the line g21, the temperature drops from the outside temperature during the hydrogen release period, and then approach the outside temperature from the temperature that has dropped during the period when hydrogen is not released.

On the other hand, when the temperature sensor 141 is abnormal, as shown in dash lines g22 to g24, the temperature drops from the outside temperature during the hydrogen release period, but does not approach the outside temperature from the temperature that has dropped during the period when hydrogen is not released.

As shown in FIGS. 2 and 3, an average value (line g26) when a plurality of temperature sensors 141 have failed is smaller than an average value (line g16) when one temperature sensor 141 has failed. When the average value is compared with a temperature at the time t13, when the temperature has almost returned to the outside air temperature after hydrogen release, since the average value becomes smaller, the temperature sensor with the largest deviation from the average value may be a normal temperature sensor (line g21), which poses a risk of false detection.

For this reason, in the present embodiment, when the temperature sensor with the highest temperature at the time t13 is detected as abnormal, it is assumed that a plurality of temperature sensors are experiencing abnormalities. A reason for this is that when the temperature sensor 141 is a thermistor, its resistance increases when it fails, which means that the failure occurs on a lower temperature side, as shown in FIG. 3.

### Detection of abnormality using deviation

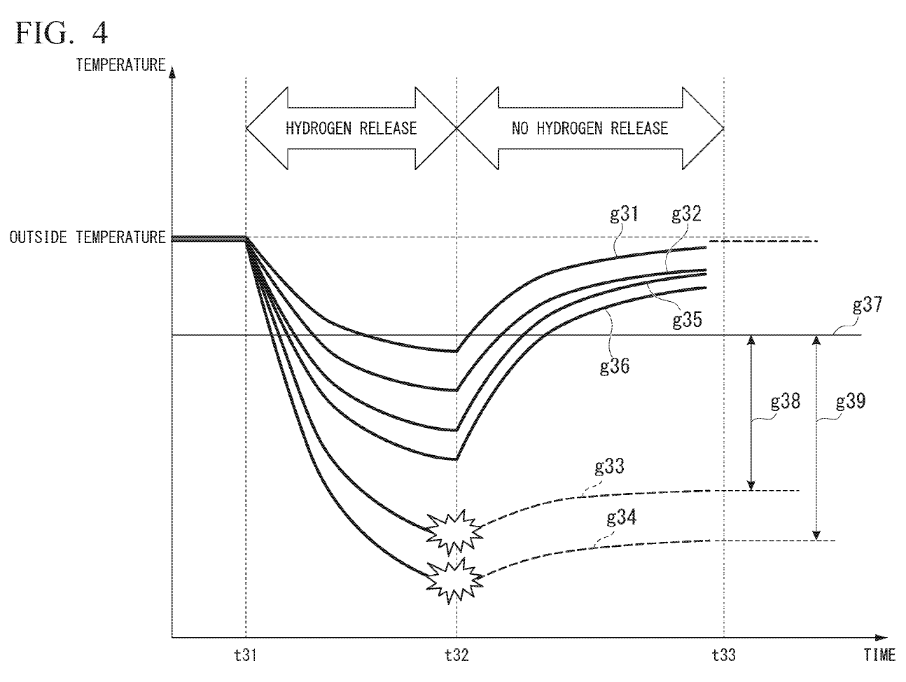

FIG. 4 is a diagram for describing an example of detecting an abnormality of a temperature sensor using a deviation. The example in FIG. 4 shows a system with six tanks, each equipped with a temperature sensor, where a temperature sensor of a third tank and a temperature sensor of a fourth tank have failed.

In FIG. 4, the horizontal axis represents a time (seconds), and the vertical axis represents a temperature (degrees). A line g31 represents a detected temperature in a first tank. A line g32 represents a detected temperature in a second tank. A dash line g33 represents a detected temperature in a third tank. A dash line g34 represents a detected temperature in a fourth tank. A line g35 represents a detected temperature in a fifth tank. A line g36 is a detected temperature in a sixth tank.

A line g37 is an average temperature value between times t31 to t33 for each temperature of the first through sixth tanks.

In the example of FIG. 4, a magnitude relationship of the deviation is, for example, in descending order of the temperature sensor of the fourth tank>the temperature sensor of the third tank>the temperature sensor of the sixth tank>the temperature sensor of the fifth tank>the temperature sensor of the second tank>the temperature sensor of the first tank.

In the example of FIG. 4, as indicated by the double-headed arrow g39, the deviation that is a difference between the temperature and the average value of the temperature sensor of the fourth tank at a time t33 is the largest among the first through sixth tanks, and the temperature at the time t33 is also the lowest (minimum value).

In this manner, when a temperature of the temperature sensor with the largest deviation is a minimum value, the temperature sensor abnormality detection part 151 determines that an abnormality has occurred in the temperature sensor with the largest deviation.

On the other hand, when the temperature of the temperature sensor with the largest deviation is a maximum value, the temperature sensor abnormality detection part 151 determines that an abnormality has occurred in a plurality of temperature sensors. In this case, since a plurality of temperature sensors 141, specifically the temperature sensor installed in the third tank and the temperature sensor installed in the fourth tank, are abnormal, when the temperature detected by the temperature sensor with the largest deviation is a maximum value, the temperature sensor abnormality detection part 151 determines that an abnormality has occurred in sensors with a minimum value and a second-to-minimum value of the temperature detected by the temperature sensor.

Note that FIGS. 3 and 4 are image diagrams for description and do not represent actual measurements or simulation results. Therefore, measurement results and changes are not limited to these.

### Example of Processing Procedure

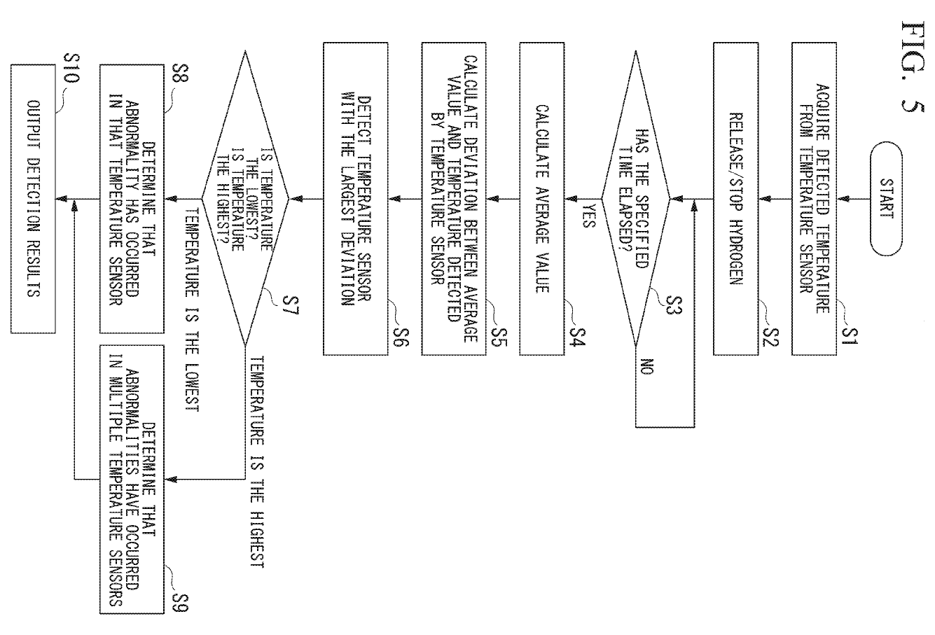

FIG. 5 is a flowchart of processing in the present embodiment.

The present technology detects abnormalities in a plurality of hydrogen tanks installed in vehicles, work machines, and the like, and in the temperature sensors installed in the plurality of tanks.

(Step S1) The temperature sensor abnormality detection part 151 acquires temperature data detected by each temperature sensor 141 at specified times.

(Step S2) The control part 152 controls valves, and the like to release hydrogen from the tank 110 when hydrogen gas is supplied to a fuel cell system while a vehicle is traveling or a work machine is operating, and to stop the release of hydrogen from the tank 110 when the fuel cell system is stopped, such as when the vehicle or work machine is stopped.

(Step S3) After the hydrogen release, the control part 152 determines whether a specified time (predetermined period) for the temperature to approach the outside temperature during a period when hydrogen is not released (after release) has elapsed. When the specified time has not elapsed (NO in step S3), the control part 152 repeats processing of step S3. When the specified time has elapsed (YES in step S3), the control part 152 proceeds to processing of step S4.

(Step S4) The temperature sensor abnormality detection part 151 calculates an average temperature value of the temperature sensor from a start of hydrogen release to an elapse of the specified time.

(Step S5) The temperature sensor abnormality detection part 151 calculates a deviation between the temperature and the average value after the specified time has elapsed for each temperature sensor.

(Step S6) The temperature sensor abnormality detection part 151 detects (identifies) a temperature sensor with the largest (maximum) deviation.

(Step S7) The temperature sensor abnormality detection part 151 determines whether a temperature of the temperature sensor with the largest deviation is the lowest (minimum value) or the highest (maximum value). When the temperature of the temperature sensor with the largest deviation is the lowest (step S7; temperature is lowest), the temperature sensor abnormality detection part 151 proceeds to processing of step S8. When the temperature of the temperature sensor with the largest deviation is the highest (step S7; temperature is highest), the temperature sensor abnormality detection part 151 proceeds to processing of step S9.

(Step S8) When the temperature of the temperature sensor with the largest deviation is a minimum value among the temperatures detected by the plurality of temperature sensors and the deviation is equal to or greater than a predetermined value, the temperature sensor abnormality detection part 151 determines that an abnormality has occurred in that temperature sensor. After processing, the temperature sensor abnormality detection part 151 proceeds to processing of step S10.

(Step S9) When the temperature of the temperature sensor with the largest deviation is a minimum value among the temperatures detected by a plurality of temperature sensors, the temperature sensor abnormality detection part 151 determines that an abnormality has occurred in a plurality of temperature sensors other than the temperature sensor with the largest deviation. After this processing, the temperature sensor abnormality detection part 151 proceeds to processing of step S10.

(Step S10) The temperature sensor abnormality detection part 151 outputs the detection result of step S8 or step S9 to the control part 152.

When a temperature detected by the temperature sensor with the maximum temperature is compared with temperatures detected by each temperature sensor, the temperature sensor abnormality detection part 151 may perform the comparison with starting from a temperature sensor with the lowest detected temperature or a temperature sensor with the lowest detected temperature among temperature sensors that have not been determined to be abnormal. Alternatively, the temperature sensor abnormality detection part 151 may perform the comparison with starting from a temperature sensor that is estimated to have a low temperature based on a tendency of a sensor among a plurality of sensors. As for estimation, the temperature may be estimated to be low based on an arrangement of a plurality of tanks.

### Control Example

Next, an example of control performed by the control part 152 when an abnormality of a temperature sensor is detected will be described. The control part 152 continues to use only the tank 110 corresponding to the temperature sensor 141 where an abnormality has been detected, with a value calculated to be lower than the remaining amount of hydrogen. In other words, after detecting the abnormality, the control part 152 sets the remaining amount to a value that is lower than the remaining amount before the sensor abnormality is detected, only for the tank corresponding to a temperature sensor where the abnormality has been detected.

In this case, for example, the control part 152 continues to use the tank 110 corresponding to the temperature sensor 141 identified in step S8 of FIG. 5, with the value calculated to be lower than the remaining amount of hydrogen. Note that lower calculating means calculating on a low-density side, i.e., a side with less fuel.

For example, the control part 152 substitutes a maximum tank temperature expected when the tank system is in use into a density calculation map (e.g., stored in the storage part 153) for calculating the remaining amount as a substitute value (for example, 50 degrees) rather than a detected value. Note that the density calculation map is associated with, for example, a tank temperature, a pressure, and the like. That is, the control part 152 controls only the tank corresponding to the temperature sensor where an abnormality is determined to occur by setting a substitute value for the remaining amount that is lower than the remaining amount before the abnormality is determined to occur.

The control part 152 then calculates the density (remaining amount) within the tank to be lower, and prevents a situation where the vehicle runs out of gas (fuel shortage) before information indicating that fuel is low is notified. Note that the control part 152 detects the remaining amount of hydrogen fuel using well-known methods, and when the remaining amount falls within a predetermined value, lights up or notifies of information indicating that fuel is low.

The tank system 1 described above can be applied to, for example, mobile objects, vehicles, electricity storage devices, and other work equipment.

In the example described above, hydrogen has been described as an example of an object to fill the tank 110, but the present invention is not limited to this.

In the example described above, the temperature sensor 141 detects the temperature inside the tank 110, but the present invention is not limited to this. The present embodiment can also be applied to a system in which a plurality of (n; n is an integer greater than or equal to 3) temperature sensors simultaneously detect temperatures in environments with the same or similar conditions, and in which the temperatures of a plurality of environments change simultaneously.

As described above, in the present embodiment, a deviation of each piece of data of tank temperatures detected by the temperature sensor is calculated, and if the deviation is equal to or greater than a predetermined value, it is determined to be a failure.

As a result, the present embodiment can detect that one of sensors in each of three or more tanks has failed.

Note that in the present embodiment, a term “determining” by the temperature sensor abnormality detection part 151 that an abnormality has occurred in the temperature sensor also includes meanings of “estimating” and “predicting.”

Note that a program for implementing all or part of functions of the temperature sensor abnormality detection part 151 or control part 152 in the present invention may be recorded on a computer-readable storage medium, and a program recorded on this recording medium may be read into a computer system and executed to perform all or part of processing performed by the temperature sensor abnormality detection part 151 or control part 152. Note that a term “computer system” here includes the OS and hardware such as peripheral devices. Moreover, the term “computer system” also includes a WWW system equipped with a homepage provision environment (or display environment). Furthermore, “computer-readable storage medium” refers to portable media such as flexible disks, optical magnetic disks, ROMs, and CD-ROMs, as well as storage devices such as hard disks built into computer systems. Furthermore, “computer-readable storage medium” also includes devices that retain a program for a certain period of time, such as a volatile memory (RAM) within a computer system that serves as a server or client when the program is transmitted over a network such as the Internet or over a communication line such as a telephone line.

Alternatively, some or all of these components may be implemented by hardware (circuit unit; including circuitry) such as a large scale integration (LSI), an application specific integrated circuit (ASIC), a field-programmable gate array (FPGA), a graphics processing unit (GPU), or a system on chip (SOC), or may be implemented by software and hardware in cooperation.

Furthermore, the program may be transmitted from a computer system storing the program in a storage device or the like to another computer system via a transmission medium or by transmission waves within the transmission medium. Here, the “transmission medium” for transmitting the program refers to a medium having a function of transmitting information, such as a network (communications network) like the Internet or a communication line (communications line) like a telephone line. The program may also be a program that realizes part of the functions described above. Furthermore, the program may be a so-called differential file (differential program) that realizes the functions described above in combination with a program already recorded in a computer system.

The above describes a form for carrying out the present invention using embodiments, but the present invention is not limited to these embodiments in any manner, and various modifications and substitutions can be made within a range not departing from the gist of the present invention.

### EXPLANATION OF REFERENCES

1 Tank system

110, 110-1, .., 110-n (n is an integer equal to or greater than 3) Tank

140, 140-1, …, 140-n Temperature sensor

151 Temperature sensor abnormality detection part

152 Control part

153 Storage part

What is claimed is:

1. A temperature sensor abnormality detection device that detects abnormalities of a plurality of temperature sensors provided in each of a plurality of tanks in a tank system having the plurality of tanks, comprising:
a temperature sensor abnormality detection part configured to calculate deviations between an average value of temperatures detected by the plurality of temperature sensors and a temperature detected by each of the plurality of temperature sensors, identify a temperature sensor with a largest deviation, determine that an abnormality has occurred in the identified temperature sensor when a temperature detected by the identified temperature sensor is a minimum value among the temperatures detected by the plurality of temperature sensors and a deviation of the identified temperature sensor is equal to or greater than a predetermined value, and determine that an abnormality has occurred in the plurality of temperature sensors other than the identified temperature sensor when a temperature detected by the identified temperature sensor is a maximum value among the temperatures detected by the plurality of temperature sensors.

2. The temperature sensor abnormality detection device according to claim 1,
wherein a temperature sensor abnormality detection part determines that an abnormality has occurred in temperature sensors with a minimum value and a second-to-minimum value of detected temperatures when a temperature detected by the identified temperature sensor is a maximum value among the temperatures detected by the plurality of temperature sensors.

3. The temperature sensor abnormality detection device according to claim 1,
wherein, when a difference between a value of a temperature sensor with the maximum detected temperature and a temperature detected by another temperature sensor is equal to or greater than a predetermined value, the temperature sensor abnormality detection part determines that an abnormality has occurred in the other temperature sensor.

4. The temperature sensor abnormality detection device according to claim 1,
wherein, when a temperature of the temperature sensor with the maximum detected temperature is compared with temperatures detected by other temperature sensors, the temperature sensor abnormality detection part performs the comparison starting from a temperature sensor with the lowest detected temperature among the other temperature sensors or a temperature sensor with the lowest detected temperature among the other temperature sensors where an abnormality has not been determined.

5. The temperature sensor abnormality detection device according to claim 1,
wherein a temperature detected by each of the plurality of temperature sensors is a temperature when a predetermined period of time has elapsed after hydrogen release and during a period when hydrogen is not released.

6. The temperature sensor abnormality detection device according to claim 1,
wherein only a tank corresponding to the temperature sensor where an abnormality is determined to have occurred by the temperature sensor abnormality detection part is provided with a control part that performs control by setting a remaining amount to a substitute value that is lower than the remaining amount before the abnormality is determined to have occurred.

7. A temperature sensor abnormality detection method for detecting abnormalities of a plurality of temperature sensors provided in each of a plurality of tanks in a tank system having the plurality of tanks, comprising:
by a computer of a temperature sensor abnormality detection device,
calculating deviations between an average value of temperatures detected by the plurality of temperature sensors and a temperature detected by each of the plurality of temperature sensors;
identifying a temperature sensor with the largest deviation;
determining that an abnormality has occurred in the identified temperature sensor when a temperature detected by the identified temperature sensor is a minimum value among the temperatures detected by the plurality of temperature sensors and a deviation of the identified temperature sensor is equal to or greater than a predetermined value; and
determining that an abnormality has occurred in the plurality of temperature sensors other than the identified temperature sensor when a temperature detected by the identified temperature sensor is a maximum value among the temperatures detected by the plurality of temperature sensors.
